(19) United States
(12) Patent Application Publication
(10) Pub. No.: US 2011/0100185 A1
(43) Pub. Date: May 5, 2011

(54) SYSTEM FOR CUTTING MULTIFILAMENT STRAND TO A PLURALITY OF FILAMENTS OF THE SAME GIVEN LENGTH

(75) Inventors: Dror Selivansky, Haifa (IL); Isaac Friedman, Ashdod (IL)

(73) Assignee: Polyssive Ltd., Haifa (IL)

(21) Appl. No.: 12/864,029

(22) PCT Filed: Jan. 21, 2009
(86) PCT No.: PCT/IL09/00081

§ 371 Date: Nov. 8, 2010

Related U.S. Application Data
(60) Provisional application No. 61/006,563, filed on Jan. 22, 2008.

(51) Int. Cl. B26D 1/143

(52) U.S. Cl. 83/648

(57) ABSTRACT

System for cutting multifilament strand into a plurality of pieces of filaments of the same given length includes a tension compensator (TC) and a cutter provided with flow directors. The TC having a surface across which a segment of said MFS is winded provides for retaining this segment of FMS at a predefined tension level. The flow directors provide for controlling the direction in which the cut pieces of filaments flow off the cutter. Additionally, methods for controlling the level of tension along a segment of the MFS and for controlling the direction in which the cut pieces of filaments flow off the cutter are provided as well.

### FIELD OF THE INVENTION

The present invention relates in general to cutters. In particular the present invention relates to systems for cutting a multifilament strand (MFS) to a plurality of pieces of filaments of a given length. The present invention further relates to a tension compensators for controlling the level of the tension exerted along a segment of the MFS, and to flow directors for guiding the flow of the cut pieces of filaments off the cutter.

### BACKGROUND OF THE INVENTION

Utilizing suspended fiber staples for reinforcing cementitious matrixes is common. European patent application EP1230452 discloses a method for reinforcing cementitious matrixes and features of the fiber staples involved. Normally such fiber staples are cut to a given length from multifilament strands (MFS) composed of the suitable materials. The relatively small dimensions and weights of the cut fibers as well as their elastic features causes them to be spread in space when are cut off the MFS. Therefore guiding the flow of cut filaments for efficiently collecting them is of practical importance.

Tensioning a segment of yarn or MFS during various treatments such as cutting, spinning and drawing is commonly applied in the industry. Various methods for controlling the level of tension along a segment of the treated MFS are known. The main drawback of common tension controllers is their relatively slow response compared to the rate in which the instantaneous level of the tension actually fluctuates.

Therefore a method for guiding the flow of cut pieces of filaments and a method for controlling the level of tension along a segment of the MFS, as well as a system for cutting MFS to a plurality of pieces of filaments of a given length that is simple to manufacture and operate are beneficial.

### BRIEF DESCRIPTION OF THE DRAWINGS

FIG. 1 is an isometric view of a system for cutting a multifilament strand (MFS) according to a preferred embodiment of the present invention;

FIG. 2 is an isometric view of a tension compensator of the system shown in FIG. 1;

FIG. 3 is a segment of the system shown in FIG. 1 shown in more details;

FIG. 4 schematically shows a blade rotating between both arms of a rail around which a segment of MFS is winded;

FIG. 5 schematically shows a spindle that tows a MFS and binds it around the rail of a system of the invention;

FIGS. 6-7 are sectional views of a segment of the cutter of the system shown in FIG. 1 respectively made at two different sectioning planes.

### DETAILED DESCRIPTION OF THE PRESENT INVENTION

In accordance with the present invention a system for cutting a multifilament strand (MFS) to a plurality of pieces of filaments of a given length is provided. A method for controlling the tension along a segment of a FMS that is continuously fed into a system of the invention and a method for controlling the flow of the cut pieces off the system are provided as well.

A system of the invention is characterized by at least one flow director that directs the flow of cut pieces of filaments off the cutter, and by a tension compensator for controlling the level of tension along a segment of the inputted FMS. The system further includes a cutter the blade of which rotates between both arms of a rail around which a portion of the MFS is winded.

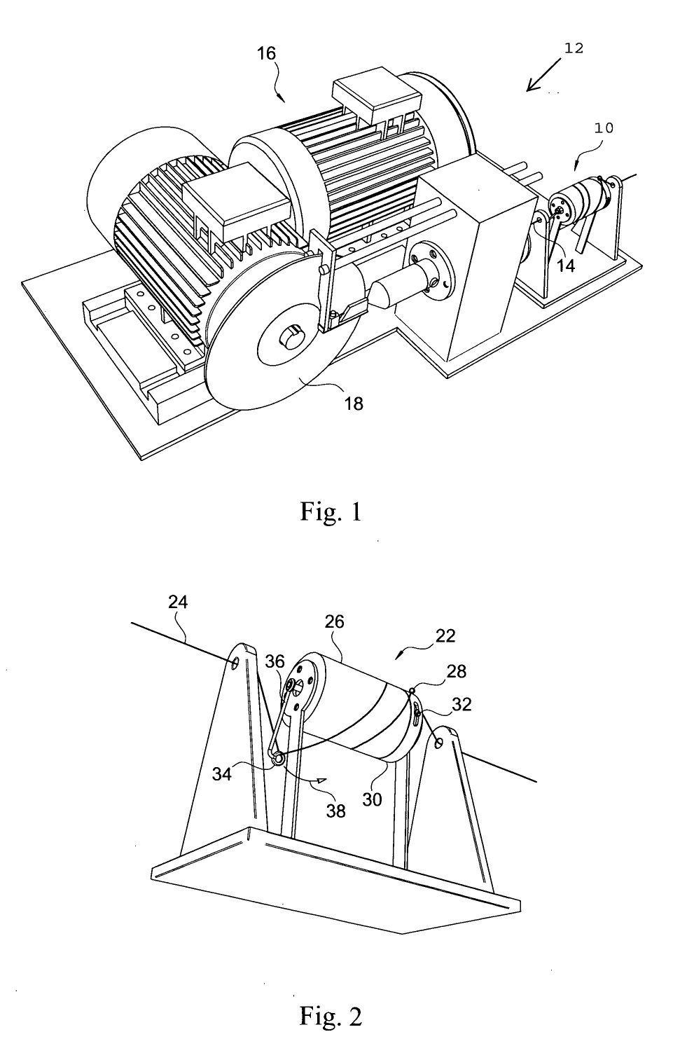

Reference is now made to FIGS. 1-3 in which a system for cutting FMS to pieces of filaments according to a preferred embodiment of the present invention, as well as details relating to its structure and features are respectively shown. In FIG. 1 an isometric view of a system for cutting MFS to a plurality of pieces of filaments of a given length according to a preferred embodiment of the present invention is shown. Tension compensator (TC) 10 of system 12 provides for retaining the level of tension along segment 14 of the MFS within a predefined range of tension levels. Segment 14 is towed into cutter 16 by means of a rotating spindle as further described infra. Cutting the MFS is accomplished by means of rotating blade 18.

Tension Compensator

TCs according to the present invention provide for exerting a counter force onto a segment of MFS by means of a biasing spring. Thereby the instantaneous tension along the segment of MFS that is towed to be fed into the cutter of a system for cutting MFS to a plurality of pieces of filaments is retained within a predefined range. A TC of the invention has a surface having an axis across which a portion of the segment that is to be towed into the cutter is winded. The length of the portion of winded MFS and/or the number of winding applied across this surface, as well as the angle in which the MFS approaches the surface and the initial tension induced onto the biasing spring are selected in consideration with the desired level of tension to be exerted along the MFS and the friction coefficient between the surface and the material from which the filaments are made of.

In FIG. 2 an isometric view of TC 22 of a system for cutting MFS to a plurality of pieces of filaments of a given length according to a preferred embodiment of the present invention is shown. A portion of segment of MFS 24 is winded across the surface of cylinder 26. Eyelet 28 that is securely attached to ring 30 provides for fixing the angle by which the MFS approaches, and the length of the portion of MFS that is bound across, the surface of cylinder 26. Ring 30 is rotatably attached to cylinder 26. The rotational angle between eyelet 28 relative to the axis of the cylinder is fixed by means of screw 32. Eye 34 disposed at the free end of flyer 36, which is pivotally attached to cylinder 26 by means of a torsion spring, not shown. In cases in which the instantaneous level of the tension along segment 24 increases, the stretched MFS rotates flyer 36 in the direction shown by curved arrow 38 thereby the length of the portion of MFS winded across the cylinder decreases. The torsion spring causes flyer 36 to move in the opposite direction back to its steady state position. Such rotation increases the length of the portion of MFS that is winded across the surface of the cylinder, thereby increasing the level of the friction forces exerted onto the winded segment of MFS. Optionally the rotation of the flyer in the same direction in which it is forced by the biasing spring is blocked at a predefined angle. Therefore the friction forces which resist the towing and the force exerted by the biasing spring have a maximal value. In turn the tension level along the towed MFS cannot get below a minimal level that is predefined. The rotational angle of eye 34 relative to the cylinder axis at the steady state position complies with the desired level of the tension along segment 24. The level of the instantaneous tension along segment 24 equals the magnitude of the vectorial sum of the force by which the segment is towed towards the cutter, the friction forces exerted by the surfaces of the cylinder and of the respective surfaces of the eyelets through which the MFS is threaded, the resisting forces exerted by the unwinded MFS and the counter force exerted by the torsion spring. The distance of eye 34 from the axis which is its radius of rotation is selected in consideration with the magnitude of the torque to be exerted by the biasing spring, the radius of the cylinder and the level of the friction coefficient between the MFS and the cylinder surface. The level of the moment of inertia of the flyer is preferably selected to be relatively low according to the present invention such that its response to the fluctuating tension is immediate and the region in which the tension level varies is relatively small.

Cutter

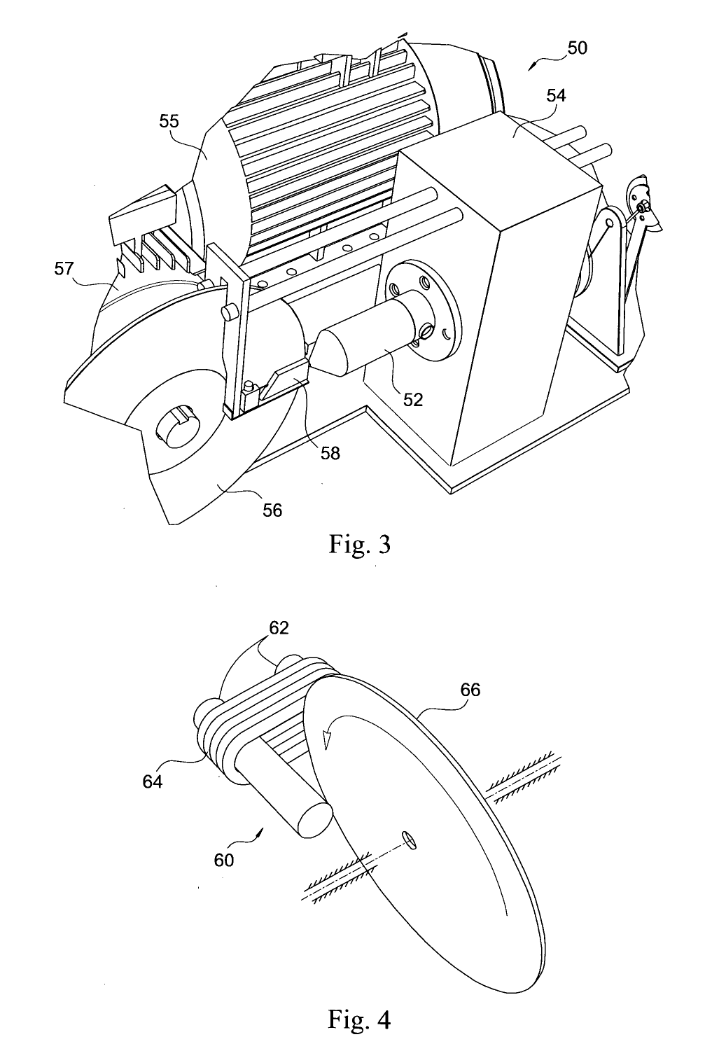

A cutter of a system of the invention has a rotating blade a segment of which is disposed between both arms of a rail. A portion of the MFS is bound around the rail by means of a conical spindle of the cutter that also provides for continuously towing the MFS towards the rotating blade. In FIG. 3, a segment of cutter 50 of a system for cutting MFS to a plurality of pieces of filaments according to a preferred embodiment of the present invention is shown. Hollow spindle 52 is connected by means of gearbox 54 and a band, not shown, to driving motor 55. Rotating blade 56 is driven by motor 57. Typically, both motors are electrically powered. Flow directors such as flow director 58 that are symmetrically disposed adjacent to both arms of the rail respectively surround each of them. The arms of the rail of this cutter, which are radially disposed with the blade, are hidden by flow director 58 and blade 56.

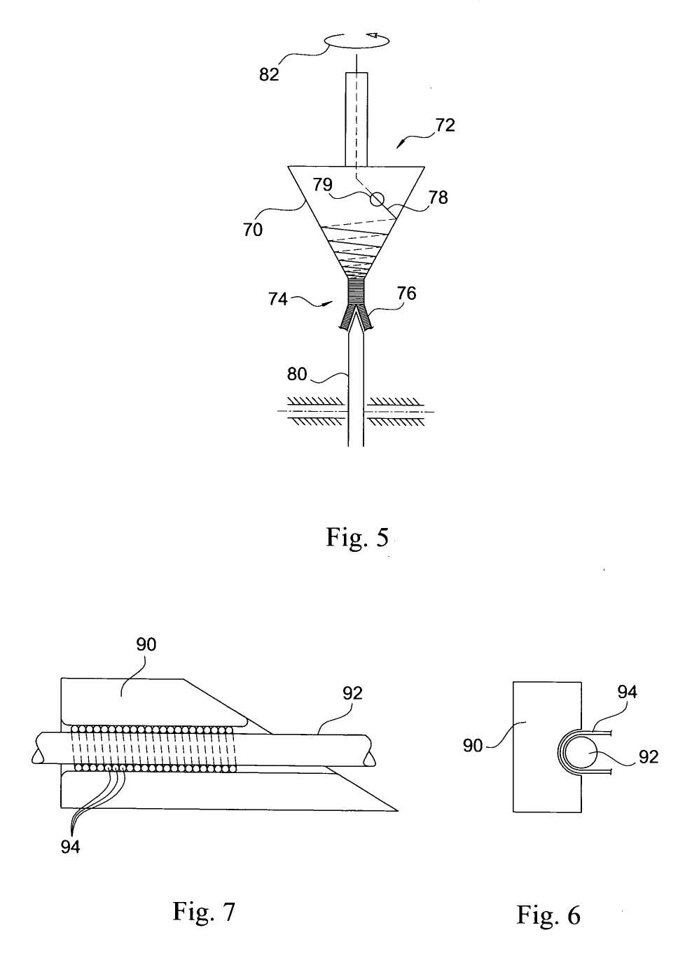

The features of the rail can be better explained with reference to FIG. 4 in which a segment of rail 60 is schematically shown bound with a portion of the MFS. Rail 60 has two arms 62 around which a portion of MFS 64 is winded. All such windings have the same perimeter. Therefore when the current extreme winding is cut by rotating blade 66, two bunches of filaments each of which is of the same length that equals half of the perimeter of a winding are generated. Reference is now made to FIG. 5 in which a spindle of a system for cutting MFS to a plurality of filaments of a given length according to a preferred embodiment of the present invention is schematically shown. The geometrical shape of segment 70 of hollow spindle 72 is of a truncated cone. The cone angle of this spindle is typically at least of 30°. Namely, the slope of the conical surface is relatively high. Therefore loops of tensioned yarn or strand winded across the conical surface are forced towards the tip of the cone, as known. The planar surface of the top of the truncated cone is disposed at a close proximity to a stem of rail 74 which is further bifurcated into two arms, such as arm 76. Portion 78 of the tensioned MFS that emerges off aperture 79 is continuously bound around the conical surface of the spindle and further winded around the stem and arms of the rail. Such winding is accomplished by the rotational motion of the spindle in the direction shown by curved arrow 82. The rotational motion of the spindle further provides for towing the MFS towards the blade as well as for twisting the towed portion of MFS.

The impact exerted by the rotating blade when it hits the outermost winding of the MFS cuts it into two halves. The lateral dimensions of the stem and the arms of the rail and the distance separating between them, are selected in consideration with the length of the perimeter of a single loop of winded MFS. The elastic energy associated with the twisted MFS provides for springing each cut piece of filament off the arm onto which it was previously bound. Flow directors of the present invention provide for directing the flow of the cut filaments off the rail as further described infra.

Flow Directors

At least one flow director surrounds an arm of the rail of a cutter of a system of the invention. The flow director is closely disposed adjacent to an arm of the rail onto which the FMS is winded. Reference is now made to FIGS. 6-7 in which a flow director of a system for cutting MFS to a plurality of pieces of filaments of a given length according to a preferred embodiment of the present invention is shown in two sectional views. Both views are respectively made towards different sectioning planes. The sectioning plane of FIG. 6 is perpendicular to the plane of the rotational blade. The sectioning plane of FIG. 7 is the plane of the blade. The same parts shown in FIGS. 6-7 are designated by the same numbers. Flow director 90 is disposed adjacent to arm 92 of the rail onto which segment 94 of MFS is winded. The elastic energy of the bended and twisted filaments is released by springing them off the rail immediately following their being cut off. The shorter ceiling of the tapered end of flow director 90 provides for springing one of the loose ends of cut filaments that surrounds arm 92 while the other end is constrained by the longer floor to stay nearby arm 92. This end is freed off the arm and its respective flow director by being continuously pushed by the following windings that successively progress along the rail. The angle by which the tapered end is beveled is selected in consideration with the width of the MFS to be cut into pieces and the lateral dimension of the arms of the rail. These factors also govern the translational speed in which the loops of MFS progress along the rail. This angle is such selected that one or a given small number of bunches of cut filaments will be held in between the flow directors and their respective arms. The major component of the rotational motion of each falling piece of filament is parallel to the plane of the rotating blade of the cutter. Such rotational motion provides for downwardly directing the cut filaments off the cutter.

### EXAMPLE

A system for cutting MFS to a plurality of filaments in accordance with the preferred embodiment described hereinabove with reference to FIG. 1 was installed in a production facility for reinforced concrete. A MFS consisting of two dozens of melt spun nylon filaments of NewCrete M type Nylon 6.6 polymer, Diameter 12 microns, Specific gravity 1.16 gm/cm³, Dtex per filament 1.5, Tenacity 350 MPa, Elastic Modulus 2,200 MPa, is cut by means of the system into a plurality of filaments of 12 mm length. The spindle of the cutter is driven by 3000 cpm rotor motor of 1.1 KW. A rotating blade of 30 cm diameter of Spring Stainless Steel, such as a product of Rockwell Hardness, is driven by a 1000 cpm rotor motor of 0.75 KW. The cut pieces of filaments are dispensed off the system into a hopper. The 12 mm filaments are further delivered from the hopper by means of Venturi suction into a hose directing them towards the mixture of materials composing the cementitious matrix. Employing any other delivery means that is suitable for delivering fibers is in accordance with the present invention.

1-26. (canceled)

27. A cutting mechanism comprising:
a pair of parallel rails spaced from one another and configured to receive a strand wound thereabout;
a cutting blade disposed between said rails and being configured to cut said strand while being so wound; and
a pair of flow directors, each flow director comprising a front end and a rear end and being disposed surrounding one of said rails adjacent said blade, giving rise to a gap between the rail and the flow director, said gap being sized so as to constrain therein the wound strand while allowing it to be pushed along said rail from said front end toward said rear end;
each of said flow directors is configured, while said wound strand is so pushed, to:
constrain the strand at said front end before cutting; and
at said rear end, to constrain a bottom side of the cut strand while a top side thereof is freed after the cutting, and to subsequently free said bottom side.

28. A cutting mechanism according to claim 27, wherein the back end of each of said flow directors is formed as a downwardly angled slope.

29. A cutting mechanism according to claim 27, wherein the bottom portion of said rear end is longer than the top portion thereof.

30. A cutting mechanism according to claim 27, wherein said blade is rotating blade.

31. A cutting mechanism according to claim 27, wherein said strand is a multi-filament strand.

32. A system for providing a plurality of pieces of strands of a given length, said system being configured to cut a strand into pieces of said length and comprising:
a cutting mechanism according to any one of the preceding claims; and
a strand feeder, configured to feed said strand to the cutting mechanism.

33. A system according to claim 32, wherein said strand feeder is configured to wind said strand around said rails.

34. A system according to claim 32, configured to supply said pieces to a concrete mixer.
